(19) United States
(12) Patent Application Publication
(10) Pub. No.: US 2022/0135746 A1
(43) Pub. Date: May 5, 2022

(54) BRANCHED HARD- AND SOFT-BLOCK COPOLYMERS

(71) Applicant: Arkema France, Colombes (FR)

(72) Inventors: Clio COCQUET, SERQUIGNY (FR); Quentin PINEAU, SERQUIGNY (FR)

(73) Assignee: Arkema France, Colombes (FR)

(21) Appl. No.: 17/434,777

(22) PCT Filed: Mar. 16, 2020
(86) PCT No.: PCT/FR2020/050545

§ 371 Date: Aug. 30, 2021

(30) Foreign Application Priority Data
Mar. 15, 2019 (FR) 1902695

(51) Int. Cl. C08G 81/00; C08J 9/00; C08J 9/12

(52) U.S. Cl. CPC C08G 81/00; C08J 9/0061; C08J 9/125; C08J 2203/10; C08G 2110/0025; C08J 2377/00; C08J 2371/02; C08G 2110/0008

(57) ABSTRACT

The invention relates to a branched copolymer containing rigid blocks and flexible blocks, wherein the branchings are made by a polyol residue binding rigid blocks of the copolymer,
said polyol being a polyol comprising at least three hydroxyl groups,
said copolymer having a weight-average molar mass Mw of greater than or equal to 80 000 g/mol, and wherein the ratio of the weight-average molar mass Mw of the copolymer to the number-average molar mass Mn of the copolymer is greater than or equal to 2.2.

The invention also relates to a process for manufacturing such a copolymer and also to a foam of such a copolymer, to a process for manufacturing such a foam and articles made from such a foam.

### FIELD OF THE INVENTION

The present invention relates to a copolymer containing rigid blocks and flexible blocks and also to a foam formed from this copolymer.

### TECHNICAL BACKGROUND

Various polymer foams are used notably in the field of sports equipment, such as soles or sole components, gloves, rackets or golf balls, personal protection items in particular for practicing sports (jackets, interior parts of helmets, shells, etc.).

Such applications require a set of particular physical properties which ensure rebound capacity, a low compression set and a capacity for enduring repeated impacts without becoming deformed and for returning to the initial shape.

Document CN 107325280 describes polyether/polyamide elastomers obtained by the copolymerization of a polyamide, a polyether and a branching agent and which can be used for the preparation of foams.

Document WO 2018/087501 describes compositions comprising a copolymer containing flexible blocks and rigid blocks and a polyol with a functionality of greater than two and the use thereof in an extrusion process, in particular for the manufacture of waterproof-breathable films.

There is a need to provide polymers enabling the formation of foams having one or more advantageous properties from among: a low density; a low compression set; a high fatigue strength in compression; and good resilience properties.

### SUMMARY OF THE INVENTION

The invention relates firstly to a branched copolymer containing rigid blocks and flexible blocks, wherein the branchings are made by a polyol residue binding rigid blocks of the copolymer,

said polyol being a polyol comprising at least three hydroxyl groups,
said copolymer having a weight-average molar mass Mw of greater than or equal to 80 000 g/mol, and wherein the ratio of the weight-average molar mass Mw of the copolymer to the number-average molar mass Mn of the copolymer is greater than or equal to 2.2.

According to certain embodiments, the copolymer has a weight-average molar mass Mw ranging from 80 000 to 300 000 g/mol, preferably from 85 000 to 200 000 g/mol, more preferentially from 90 000 to 175 000 g/mol.

According to certain embodiments, the ratio of the weight-average molar mass Mw of the copolymer to the number-average molar mass Mn of the copolymer is greater than or equal to 2.4.

According to certain embodiments, the ratio of the z-average molar mass Mz of the copolymer to the weight-average molar mass Mw of the copolymer is greater than or equal to 1.8, preferably greater than or equal to 2.

According to certain embodiments, the rigid blocks are chosen from polyamide blocks, polyester blocks, polyurethane blocks and a combination thereof.

According to certain embodiments, the flexible blocks are chosen from polyether blocks, polyester blocks, and a combination thereof.

According to certain embodiments, the copolymer is a copolymer containing polyamide blocks and polyether blocks.

According to certain embodiments, the polyamide blocks are blocks of polyamide 6, of polyamide 11, of polyamide 12, of polyamide 5.4, of polyamide 5.9, of polyamide 5.10, of polyamide 5.12, of polyamide 5.13, of polyamide 5.14, of polyamide 5.16, of polyamide 5.18, of polyamide 5.36, of polyamide 6.4, of polyamide 6.9, of polyamide 6.10, of polyamide 6.12, of polyamide 6.13, of polyamide 6.14, of polyamide 6.16, of polyamide 6.18, of polyamide 6.36, of polyamide 10.4, of polyamide 10.9, of polyamide 10.10, of polyamide 10.12, of polyamide 10.13, of polyamide 10.14, of polyamide 10.16, of polyamide 10.18, of polyamide 10.36, of polyamide 10.T, of polyamide 12.4, of polyamide 12.9, of polyamide 12.10, of polyamide 12.12, of polyamide 12.13, of polyamide 12.14, of polyamide 12.16, of polyamide 12.18, of polyamide 12.36, of polyamide 12.T or mixtures thereof, or copolymers thereof, preferably of polyamide 11, of polyamide 12, of polyamide 6 or of polyamide 6.10.

According to certain embodiments, the polyether blocks are blocks of polyethylene glycol, of propylene glycol, of polytrimethylene glycol, of polytetrahydrofuran, or mixtures thereof, or copolymers thereof, preferably of polyethylene glycol or of polytetrahydrofuran.

### According to Certain Embodiments

the rigid blocks of the copolymer have a number-average molar mass of from 400 to 20 000 g/mol, preferably from 500 to 10 000 g/mol; and/or
the flexible blocks of the copolymer have a number-average molar mass of from 100 to 6000 g/mol, preferably from 200 to 3000 g/mol.

According to certain embodiments, the mass ratio of the rigid blocks relative to the flexible blocks of the copolymer is from 0.1 to 20, preferably from 0.3 to 3, even more preferentially from 0.3 to 0.9.

According to certain embodiments, the polyol has a weight-average molar mass of less than or equal to 3000 g/mol, preferably less than or equal to 2000 g/mol, and more preferentially within the range of from 50 to 1000 g/mol.

According to certain embodiments, the polyol is chosen from: pentaerythritol, trimethylolpropane, trimethylolethane, hexanetriol, diglycerol, methylglucoside, tetraethanol, sorbitol, dipentaerythritol, cyclodextrin, polyether polyols comprising at least three hydroxyl groups, and mixtures thereof.

The invention also relates to a foam of a copolymer containing rigid blocks and flexible blocks as described above.

According to certain embodiments, the foam has a density of less than or equal to 800 kg/m³, preferably less than or equal to 600 kg/m³, more preferentially less than or equal to 400 kg/m³, more preferentially still less than or equal to 300 kg/m³.

According to certain embodiments, the foam has a compression set after 30 minutes of less than or equal to 35%, preferably less than or equal to 30%.

The invention also relates to a process for manufacturing a copolymer containing rigid blocks and flexible blocks as described above, comprising the following steps:
the mixing of the polyol with precursors of the rigid blocks;
the synthesis of the rigid blocks;
the addition of the flexible blocks;
the condensation of the rigid blocks and of the flexible blocks.

According to certain embodiments, the polyol is mixed in an amount ranging from 0.01% to 10% by weight, preferably from 0.01% to 5% by weight, more preferably from 0.05% to 0.5% by weight, relative to the total weight of the polyol, of the precursors of the rigid blocks and of the flexible blocks.

The invention also relates to a process for manufacturing a foam as described above, comprising the following steps:
the mixing of the copolymer in the melt state, optionally with one or more additives, and with a blowing agent; and
the foaming of the mixture of copolymer and blowing agent.

The invention also relates to an article consisting of a foam as described above.

The invention also relates to an article comprising at least one element consisting of a foam as described above.

According to certain embodiments, the article is chosen from sports shoe soles, large or small balls, gloves, personal protective equipment, rail tie pads, motor vehicle parts, construction parts and electrical and electronic equipment parts.

The present invention makes it possible to meet the need expressed above. It more particularly provides a copolymer containing rigid blocks and flexible blocks having improved foamability and enabling the formation of a homogeneous, regular polymer foam having a low density and having one or more advantageous properties from among: a high capacity for restoring elastic energy during low-stress loading; a low compression set (and therefore improved durability); a high fatigue strength in compression; and excellent resilience properties. According to certain particular embodiments, the foam according to the invention is also recyclable.

This is accomplished using a copolymer containing rigid blocks and flexible blocks having a specific weight-average molar mass and a specific polydispersity, and that is branched by means of a particular polyol residue binding rigid blocks of the copolymer.

### DETAILED DESCRIPTION

The invention is now described in greater detail and in a nonlimiting manner in the description that follows.

Unless otherwise indicated, all the percentages are mass percentages.

The invention relates to rigid blocks and flexible blocks. These copolymers are thermoplastic elastomer (TPE) polymers comprising blocks that are rigid (or hard, with rather thermoplastic behavior) and blocks that are flexible (or soft, with rather elastomeric behavior).

A “rigid block” is understood to mean a block which has a melting point. The presence of a melting point can be determined by differential scanning calorimetry, according to the standard ISO 11357-3: 2011 Plastics-Differential scanning calorimetry (DSC) Part 3.

A “soft block” is understood to mean a block having a glass transition temperature (Tg) less than or equal to 0° C. The glass transition temperature can be determined by differential scanning calorimetry, according to the standard ISO 11357-2: 2011 Plastics-Differential scanning calorimetry (DSC) Part 2.

The rigid blocks of the copolymer according to the invention are preferably chosen from polyamide blocks, polyester blocks, polyurethane blocks and a combination thereof. Such blocks are for example described in French patent application FR 2936803 A1.

Preferably, the rigid blocks are polyamide blocks.

Three types of polyamide blocks may advantageously be used.

According to a first type, the polyamide blocks originate from the condensation of a dicarboxylic acid, in particular those containing from 4 to 20 carbon atoms, preferably those containing from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and PA 10.18 are used. In the notation PA X.Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 12 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are PA 11 (polyundecanamide), PA 12 (polydodecanamide) or PA 6 (polycaprolactam) blocks. In the notation PA X, X represents the number of carbon atoms derived from amino acid residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y);
said comonomer(s) {Z} being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or from at least two lactams containing from 6 to 12 carbon atoms or from one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by the company Croda, or under the brand name Empol by the company BASF, or under the brand name Radiacid by the company Oleon, and polyoxyalkylene α,ω-diacids. As examples of aromatic diacids, mention may be made of terephthalic acid (T) and isophthalic acid (I). As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6, in which 6.6 denotes hexamethylenediamine units condensed with adipic acid and 6 denotes units resulting from the condensation of caprolactam;
PA 6.6/6.10/11/12 in which 6.6 denotes hexamethylenediamine condensed with adipic acid, 6.10 denotes hexamethylenediamine condensed with sebacic acid, 11 denotes units resulting from the condensation of aminoundecanoic acid, and 12 denotes units resulting from the condensation of lauryllactam.

The notations PA X/Y, PA X/Y/Z, etc. relate to copolyamides in which X, Y, Z, etc. represent homopolyamide units as described above.

Advantageously, the polyamide blocks of the copolymer used in the invention comprise polyamide PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36 or PA 12.T blocks, or mixtures or copolymers thereof; and preferably comprise polyamide PA 6, PA 11, PA 12, PA 6.10, PA 10.10 or PA 10.12 blocks, or mixtures or copolymers thereof.

The flexible blocks of the copolymer according to the invention can in particular be chosen from polyether blocks, polyester blocks, polysiloxane blocks, such as polydimethylsiloxane (or PDMS) blocks, polyolefin blocks, polycarbonate blocks, and mixtures thereof.

Possible flexible blocks are described for example in French patent application FR 2941700 A1, from page 32 line 3 to page 33 line 15, from page 34 line 16 to page 37 line 13 and on page 38 lines 6 to 23.

Preferably, the flexible blocks are chosen from polyether blocks, polyester blocks, and a combination thereof.

Particularly advantageously, the flexible blocks are polyether blocks.

The polyether blocks are formed from alkylene oxide units.

The polyether blocks may notably be PEG (polyethylene glycol) blocks, i.e. blocks formed from ethylene oxide units, and/or PPG (propylene glycol) blocks, i.e. blocks formed from propylene oxide units, and/or PO3G (polytrimethylene glycol) blocks, i.e. blocks formed from polytrimethylene glycol ether units, and/or PTMG (polytetramethylene glycol) blocks, i.e. blocks formed from tetramethylene glycol units, also known as polytetrahydrofuran. The copolymers may comprise in their chain several types of polyethers, the copolyethers possibly being in block or statistical form.

Use may also be made of blocks obtained by oxyethylation of bisphenols, for instance bisphenol A. The latter products are notably described in EP 613 919.

The polyether blocks may also be formed from ethoxylated primary amines. As examples of ethoxylated primary amines, mention may be made of the products of formula:

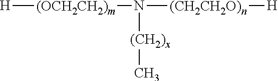

in which m and n are integers between 1 and 20, and x is an integer between 8 and 18. These products are for example commercially available under the brand name Noramox® from the company CECA and under the brand name Genamin® from the company Clariant.

The flexible polyether blocks may comprise polyoxyalkylene blocks bearing NH₂ chain ends, such blocks being able to be obtained by cyanoacetylation of α,ω-dihydroxylated aliphatic polyoxyalkylene blocks referred to as polyetherdiols. More particularly, the commercial products Jeffamine or Elastamine may be used (for example Jeffamine® D400, D2000, ED 2003, XTJ 542, which are commercial products from the company Huntsman, also described in JP 2004/346274, JP 2004/352794 and EP 1482011).

The polyether diol blocks are either used in unmodified form and copolycondensed with rigid blocks bearing carboxylic end groups, or are aminated to be converted into polyetherdiamines and condensed with rigid blocks bearing carboxylic end groups.

Preferably, the copolymers according to the invention are copolymers containing polyester blocks and polyether blocks (also called COPEs or copolyetheresters), copolymers containing polyurethane blocks and polyether blocks (also called TPUs or thermoplastic polyurethanes) or copolymers containing polyamide blocks and polyether blocks (also called PEBAs according to the IUPAC, or else polyether-block-amides).

While the block copolymers described above comprise at least one rigid block and at least one flexible block as described above, the present invention also covers the copolymers comprising three, four (or even more) different blocks chosen from those described in the present description, provided that these blocks include at least rigid and flexible blocks.

For example, the copolymer according to the invention can be a segmented block copolymer comprising three different types of blocks (or “triblock” copolymer), which results from the condensation of several of the blocks described above. Said triblock may for example be a copolymer comprising a polyamide block, a polyester block and a polyether block or a copolymer comprising a polyamide block and two different polyether blocks, for example a PEG block and a PTMG block.

Particularly advantageously, the copolymer according to the invention is a copolymer containing polyamide blocks and polyether blocks (or PEBA).

PEBAs result from the polycondensation of polyamide blocks bearing reactive ends with polyether blocks bearing reactive ends, such as, inter alia, the polycondensation:

1) of polyamide blocks bearing diamine chain ends with polyoxyalkylene blocks bearing dicarboxylic chain ends;

2) of polyamide blocks bearing dicarboxylic chain ends with polyoxyalkylene blocks bearing diamine chain ends, obtained, for example, by cyanoethylation and hydrogenation of a, w-dihydroxylated aliphatic polyoxyalkylene blocks, known as polyetherdiols;

3) of polyamide blocks bearing dicarboxylic chain ends with polyetherdiols, the products obtained being, in this particular case, polyetheresteramides.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

PEBA copolymers that are particularly preferred in the context of the invention are copolymers including blocks from among:
PA 11 and PEG;
PA 11 and PTMG;
PA 12 and PEG;
PA 12 and PTMG;
PA 6.10 and PEG;
PA 6.10 and PTMG;
PA 6 and PEG;
PA 6 and PTMG.

The number-average molar mass of the rigid blocks in the copolymer according to the invention is preferably from 400 to 20 000 g/mol, more preferentially from 500 to 10 000 g/mol, even more preferentially from 600 to 6000 g/mol. In certain embodiments, the number-average molar mass of the rigid blocks in the PEBA copolymer is from 400 to 500 g/mol, or from 500 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the flexible blocks is preferably from 100 to 6000 g/mol, more preferentially from 200 to 3000 g/mol. In certain embodiments, the number-average molar mass of the flexible blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

The number-average molar mass is set by the content of chain limiter. It may be calculated according to the equation:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of diacid limiter in excess, MW_{repeating unit} represents the molar mass of the repeating unit, and MW_{chain limiter} represents the molar mass of the diacid in excess.

The number-average molar mass of the rigid blocks and of the flexible blocks can be measured before the copolymerization of the blocks by gel permeation chromatography (GPC).

Advantageously, the mass ratio of the rigid blocks relative to the flexible blocks of the copolymer is from 0.1 to 20, preferably from 0.3 to 3, even more preferentially from 0.3 to 0.9. In particular, the mass ratio of the rigid blocks relative to the flexible blocks of the copolymer may be from 0.1 to 0.2, or from 0.2 to 0.3, or from 0.3 to 0.4, or from 0.4 to 0.5, or from 0.5 to 0.6, or from 0.6 to 0.7, or from 0.7 to 0.8, or from 0.8 to 0.9, or from 0.9 to 1, or from 1 to 1.5, or from 1.5 to 2, or from 2 to 2.5, or from 2.5 to 3, or from 3 to 3.5, or from 3.5 to 4, or from 4 to 4.5, or from 4.5 to 5, or from 5 to 5.5, or from 5.5 to 6, or from 6 to 6.5, or from 6.5 to 7, or from 7 to 7.5, or from 7.5 to 8, or from 8 to 8.5, or from 8.5 to 9, or from 9 to 9.5, or from 9.5 to 10, or from 10 to 11, or from 11 to 12, or from 12 to 13, or from 13 to 14, or from 14 to 15, or from 15 to 16, or from 16 to 17, or from 17 to 18, or from 18 to 19, or from 19 to 20.

Preferably, the copolymer of the invention has an instantaneous hardness of less than or equal to 72 Shore D, more preferably less than or equal to 68 Shore D. The hardness measurements may be performed according to the standard ISO 868:2003.

The copolymer according to the invention is a branched copolymer. It is characterized by a functionality of greater than 2 and a broad molar mass distribution.

The branched copolymer containing rigid blocks and flexible blocks has a weight-average molar mass Mw of greater than 80 000 g/mol. Preferably, the weight-average molar mass of the copolymer is from 80 000 to 300 000 g/mol, more preferentially from 85 000 to 200 000 g/mol, more preferentially still from 90 000 to 175 000 g/mol. The weight-average molar mass is expressed as PMMA equivalents (used as a calibration standard) and can be measured by size exclusion chromatography according to the standard ISO 16014-1: 2012, the copolymer being dissolved in hexafluoroisoproponol stabilized with 0.05 M potassium trifluoroacetate for 24 h at room temperature at a concentration of 1 g/L before being passed through the columns, for example at a flow rate of 1 ml/min, the molar mass being measured by the refractive index. Size exclusion chromatography can be performed using columns of modified silica, for example on a set of two columns and a pre-column of modified silica (such as the PGF columns and pre-columns from Polymer Standards Service) comprising a 1000 Å column, with dimensions of 300×8 mm and a particle size of 7 μm, a 100 Å column, with dimensions of 300×8 mm and a particle size of 7 μm and a pre-column with dimensions of 50×8 mm, for example at a temperature of 40° C. In certain embodiments, the branched copolymer containing rigid blocks and flexible blocks has a weight-average molar mass Mw ranging from 80 000 to 90 000 g/mol, or from 90 000 to 100 000 g/mol, or from 100 000 g/mol to 125 000 g/mol, or from 125 000 to 150 000 g/mol, or from 150 000 to 175 000 g/mol, or from 175 000 to 200 000 g/mol, or from 200 000 to 225 000 g/mol, or from 225 000 to 250 000 g/mol, or from 250 000 to 275 000 g/mol, or from 275 000 to 300 000 g/mol.

The branched copolymer containing rigid blocks and flexible blocks may have a number-average molar mass Mn ranging from 30 000 to 100 000 g/mol, preferably from 35 000 to 80 000 g/mol, more preferentially from 40 000 to 70 000 g/mol. The number-average molar mass is expressed as PMMA equivalents and can be measured according to the standard ISO 16014-1 according to the method described above. In certain embodiments, the branched copolymer containing rigid blocks and flexible blocks has a number-average molar mass Mn ranging from 30 000 to 35 000 g/mol, or from 35 000 to 40 000 g/mol, or from 40 000 to 45 000 g/mol, or from 45 000 to 50 000 g/mol, or from 50 000 to 55 000 g/mol, or from 55 000 to 60 000 g/mol, or from 60 000 to 70 000 g/mol, or from 70 000 to 80 000 g/mol, or from 80 000 to 90 000 g/mol, or from 90 000 to 100 000 g/mol.

The branched copolymer containing rigid blocks and flexible blocks has a z-average molar mass Mz ranging from 200 000 to 500 000 g/mol. The z-average molar mass is expressed as PMMA equivalents and can be measured according to the standard ISO 16014-1 according to the method described above. In certain embodiments, the branched copolymer containing rigid blocks and flexible blocks has a z-average molar mass Mz ranging from 200 000 to 250 000 g/mol, or from 250 000 to 300 000 g/mol, ou de 300 000 to 350 000 g/mol, or from 350 000 to 400 000 g/mol, or from 400 000 to 450 000 g/mol, or from 450 000 to 500 000 g/mol.

The polydispersity of the copolymer can be defined by the ratio of the weight-average molar mass Mw of the copolymer to the number-average molar mass Mn of the copolymer (Mw/Mn molar mass ratio) and/or by the ratio of the z-average molar mass Mz of the copolymer to the weight-average molar mass Mw of the copolymer (Mz/Mw molar mass ratio).

The copolymer according to the invention has an Mw/Mn molar mass ratio of greater than or equal to 2.2, preferably greater than or equal to 2.4. In certain embodiments, the copolymer has an Mw/Mn molar mass ratio of greater than or equal to 2.3, or greater than or equal to 2.4, or greater than or equal to 2.5, or greater than or equal to 2.6, or greater than or equal to 2.7, or greater than or equal to 2.8, or greater than or equal to 2.9, or greater than or equal to 3.

The copolymer according to the invention may have an Mw/Mn molar mass ratio of less than or equal to 7, preferably less than or equal to 6.5, more preferably less than or equal to 6.

The copolymer according to the invention may have an Mz/Mw molar mass ratio of greater than or equal to 1.8, preferably greater than or equal to 2. In certain embodiments, the copolymer has an Mz/Mw molar mass ratio of greater than or equal to 1.9, or greater than or equal to 2, or greater than or equal to 2.1, or greater than or equal to 2.2, or greater than or equal to 2.3, or greater than or equal to 2.4, or greater than or equal to 2.5.

The copolymer according to the invention may have an Mz/Mw molar mass ratio of less than or equal to 5, preferably less than or equal to 4.5, preferably less than or equal to 4.

### Synthesis of the Copolymer

The copolymer according to the invention is prepared by the addition during its synthesis of one or more polyols comprising at least three hydroxyl groups.

In general and known manner, polymers containing rigid blocks and flexible blocks can be prepared according to a two-step preparation process (comprising a first step of synthesis of the rigid blocks then a second step of condensation of the rigid and flexible blocks) or by a one-step preparation process. The polyol is added with the precursors of the rigid blocks.

The general method for two-step preparation (i.e. a first step of synthesis of the polyamide blocks then a second step of condensation of the polyamide and polyether blocks) of the PEBA copolymers having ester bonds between the PA blocks and the PE blocks is known and is described, for example, in document FR 2846332. The general method for the preparation of the PEBA copolymers having amide bonds between the PA blocks and the PE blocks is known and is described, for example, in document EP 1482011. The polyether blocks may also be mixed with polyamide precursors and a diacid chain limiter to prepare polymers containing polyamide blocks and polyether blocks having randomly distributed units (one-step process). Regardless of the method used (two-step or one-step), the polyol is added with the polyamide precursors.

Preferably, the copolymer according to the invention is prepared according to a two-step preparation process. Preferably, the copolymer according to the invention is prepared according to a process comprising the following steps:
the mixing of the polyol with precursors of the rigid blocks;
the synthesis of the rigid blocks;
the addition of the flexible blocks;
the condensation of the rigid blocks and of the flexible blocks.

The addition of a polyol with a functionality of greater than two gives rise to bridging bonds connecting together rigid blocks of the copolymer, preferably by ester bonds.

A polyol comprising at least three hydroxyl groups is understood to mean in particular:
monomeric polyols, in particular monomeric aliphatic triols such as glycerol, trimethylolpropane, pentaerythritol, and/or
polymeric polyols, in particular triols containing polyether chains, polycaprolactone triols, mixed polyether-polyester polyols comprising at least three hydroxyl groups.

Advantageously, the polyol is chosen from: pentaerythritol, trimethylolpropane, trimethylolethane, hexanetriol, diglycerol, methylglucoside, tetraethanol, sorbitol, dipentaerythritol, cyclodextrin, polyether polyols comprising at least three hydroxyl groups, and mixtures thereof.

The weight-average molar mass of the polyol is preferably at most 3000 g/mol, more preferentially at most 2000 g/mol; and is generally in the range of from 50 to 1000 g/mol, preferably from 50 to 500 g/mol, preferably from 50 to 200 g/mol.

Advantageously, the polyol is added in an amount of from 0.01% to 10% by weight, preferably from 0.01% to 5% by weight, more preferably from 0.05% to 0.5% by weight, relative to the total weight of the polyol, of the precursors of the rigid blocks and of the flexible blocks. The polyol is advantageously added in an amount of 3.5 to 35 μeq/g relative to the total weight of the polyol, of the precursors of the rigid blocks and of the flexible blocks.

### Foam

The branched copolymer containing rigid blocks and flexible blocks can be used for forming a foam, preferably without a crosslinking step. The foam is formed by mixing the copolymer in the melt state with a blowing agent, followed by performing a foaming step.

According to certain embodiments, the foam thus formed consists essentially of, or even consists of, the copolymer described above (or the copolymers, if a mixture of copolymers is used) and optionally the blowing agent, if the latter remains present in the pores of the foam, notably if it is a foam with closed pores.

The copolymer containing rigid blocks and flexible blocks may be combined with various additives, for example copolymers of ethylene and vinyl acetate or EVA (for example those sold under the name Evatane® by Arkema), or copolymers of ethylene and of acrylate, or copolymers of ethylene and of alkyl (meth)acrylate, for example those sold under the name Lotryl® by Arkema. These additives may make it possible to adjust the hardness of the foamed part, its appearance and its comfort. The additives may be added in a content of from 0 to 50% by mass, preferentially from 5% to 30% by mass, relative to the copolymer containing rigid blocks and flexible blocks.

The blowing agent may be a chemical or physical agent, or may also consist of any type of hollow object or any type of expandable microsphere. Preferably, it is a physical agent, for instance dinitrogen or carbon dioxide, or a hydrocarbon, chlorofluorocarbon, hydrochlorocarbon, hydrofluorocarbon or hydrochlorofluorocarbon (saturated or unsaturated). For example, butane or pentane may be used. Also preferably, it can also be a chemical agent such as, for example, azodicarbonamide or mixtures based on citric acid and sodium hydrogen carbonate (NaHCO₃) (such as the product in the Hydrocerol® range from Clariant).

A physical blowing agent is mixed with the copolymer in liquid or supercritical form and then converted into the gaseous phase during the foaming step.

According to preferred embodiments, the mixture of the copolymer and of the blowing agent is injected into a mold, and foaming takes place by opening the mold. This technique makes it possible directly to produce three-dimensional foamed objects with complex geometries.

It is also a technique that is relatively simple to perform, notably in comparison with certain processes of melting foamed particles as described in the prior art: specifically, filling of the mold with foamed polymer granules followed by melting of the particles to ensure the mechanical strength of the parts without destroying the structure of the foam are difficult operations.

Other foaming techniques that can be used are in particular “batch” foaming, extrusion foaming, such as single-screw or twin-screw extrusion foaming, autoclave foaming, microwave foaming and other injection molding foaming techniques (with breathable mold, with application of gas backpressure, under metering, or with a mold equipped with a Variotherm® system).

The foam according to the invention preferably has a density of less than or equal to 800 kg/m³, more preferentially less than or equal to 600 kg/m³, even more preferentially less than or equal to 400 kg/m³ and particularly preferably less than or equal to 300 kg/m³. It may, for example, have a density of from 25 to 800 kg/m³ and more particularly preferably from 50 to 600 kg/m³. The density may be controlled by adapting the parameters of the manufacturing process.

Preferably, this foam has a rebound resilience, according to the standard ISO 8307: 2007, of greater than or equal to 50%, preferably greater than or equal to 55%.

Preferably, this foam has a compression set after 30 minutes, according to the standard ISO 7214: 2012, of less than or equal to 35%, and more particularly preferably less than or equal to 30%, or less than or equal to 25%.

Preferably, this foam also has excellent properties in terms of fatigue strength and dampening.

The foam according to the invention may be used for manufacturing sports equipment, such as sports shoe soles, ski shoes, midsoles, insoles or functional sole components, in the form of inserts in the various parts of the sole (for example the heel or the arch), or else shoe upper components in the form of reinforcements or inserts into the structure of the shoe upper, or in the form of protections.

It may also be used for manufacturing inflatable balls, sports gloves (for example football gloves), golf ball components, rackets, protective elements (jackets, helmet interior elements, shells, etc.).

The foam according to the invention has advantageous impact-resistance, vibration-resistance and anti-noise properties, combined with haptic properties suitable for capital goods. It may thus also be used for manufacturing railroad rail tie pads, or various parts in the motor vehicle industry, in transport, in electrical and electronic equipment, in construction or in the manufacturing industry.

According to advantageous embodiments, the foam objects according to the invention can be readily recycled, for example by melting them in an extruder equipped with a degassing outlet (optionally after having chopped them into pieces).

### EXAMPLES

The examples that follow illustrate the invention without limiting it.

### Example 1

Four PEBAs were tested.

PEBAs nos. 1, 2 and 3 are all PEBA copolymers comprising PA 11 blocks having a number-average molar mass of 600 g/mol and PTMG blocks having a number-average molar mass of 1000 g/mol and a hardness of 32 Shore D. PEBA no. 4 is a PEBA copolymer comprising PA 11 blocks having a number-average molar mass of 1500 g/mol, PTMG blocks having a number-average molar mass of 2000 g/mol and Priplast™ 1838 polyester blocks having a number-average molar mass of 2000 g/mol.

PEBA no. 1 is a linear PEBA. PEBAs nos. 2, 3 and 4 are branched PEBAs, prepared by adding respectively 0.1% by weight (relative to the total weight of the polyol and of the other reactants of the copolymer) of trimethylolpropane (TMP), 0.15% by weight of trimethylolpropane and 0.1% by weight of pentaerythritol (PET) during their synthesis.

The PEBAs are prepared as indicated below.

PEBA no. 1:

In an autoclave, 13 kg of 11-aminoundecanoic acid, 3.8 kg of adipic acid and 4 kg of water are introduced (loading). The reactor is closed, inerted with nitrogen and then stirred and heated under autogenous pressure to 245° C. material. This temperature is maintained for 1 h, the pressure being 31 bar relative. The reactor is depressurized to atmospheric pressure over 1 h. The material temperature is 240° C. 26.1 kg of PTMG 1000 are added, then the reactor is placed under vacuum to a pressure below 15 mbar. 86 g of Irganox 1010, then 64 g of zirconium tetrabutoxide are introduced. The viscosification of the reaction medium is then monitored by measuring the stirring torque. The reaction is stopped when the torque has reached a predefined value. The reactor is then emptied into a water tank and granulated.

PEBA no. 2:

PEBA no. 2 is prepared by the same process as PEBA no. 1, except that 43 g of trimethylolpropane are also added to the loading.

PEBA 3:

PEBA no. 3 is prepared by the same process as PEBA no. 1, except that 3.9 kg of adipic acid are used instead of 3.8 kg and that 64 g of trimethylolpropane are also added to the loading.

PEBA no. 4:

PEBA no. 4 is prepared by the same process as PEBA no. 1, except that:
the loading is as follows: 2 kg of adipic acid, 15.6 kg of 11-aminoundecanoic acid, 43 g of pentaerythritol and 4 kg of water;
in the 2^{nd} step, 4 kg of PTMG 2000 and 21.4 kg of Priplast™ 1838 are loaded;
finally, 86 g of Irganox 1010 and 64 g of zirconium tetrabutoxide are added.

PEBAs nos. 1 and 4 correspond to counter-examples, PEBAs nos. 2 and 3 are PEBAs according to the invention.

The PEBAs have the following characteristics:

| PEBA | Inherent | Mn | Mw | Mz | Ratio | Ratio |
|---|---|---|---|---|---|---|
| no. | viscosity | (g/mol) | (g/mol) | (g/mol) | Mw/Mn | Mz/Mw |
| 1 | 1.7 | 48 000 | 107 000 | 183 000 | 2.2 | 1.7 |
| 2 | 1.67 | 50 000 | 145 800 | 355 700 | 2.9 | 2.4 |
| 3 | 1.7 | 52 000 | 140 800 | 318 200 | 2.7 | 2.3 |
| 4 | 0.93 | 12 100 | 78 200 | 392 200 | 6.5 | 5 |

The weight-average molar masses Mw, number-average molar masses Mn and z-average molar masses Mz of PEBAs are expressed as PMMA equivalents and are measured by size exclusion chromatography (or gel permeation chromatography) according to the standard ISO 16014-1 according to the method as described above.

The inherent viscosity is measured using an Ubbelohde tube. The measurement is taken at 20° C. on a 75 mg sample at a concentration of 0.5% (m/m) in m-cresol. The inherent viscosity is expressed in (g/100 g)⁻¹ and is calculated according to the following formula:

Inherent viscosity=ln(tₛ/t₀)×1/C, with C=m/p×100,

in which tₛ is the flow time of the solution, to is the flow time of the solvent, m is the mass of the sample whose viscosity is determined and p is the mass of the solvent. This measurement corresponds to the standard ISO 307 apart from the fact that the measuring temperature is 20° C. instead of 25° C.

Foams are prepared from PEBAs nos. 1, 2, 3 and 4.

These foams are manufactured using an ENGEL 160T Victory injection molding machine, with a system for injecting a physical blowing agent of Trexel series II type. The operating parameters are as follows:
Barrel temperature: 190 to 210° C.
Hold time before opening the mold: 17 to 28 s.
Cooling time: 120 to 180 s.
Mold temperature: 35-60° C.
Mold opening length: up to 12 mm.
Mold: plate mold with dimensions of 2×100×100 mm.

The foaming agent used is dinitrogen, introduced in a proportion of 0.7% by weight.

Various properties of the foams obtained are evaluated:
density: according to the standard ISO 845;
Δ density: characterizes the homogeneity of the foam and corresponds to the difference in density of the foamed part between the point closest to the injection point and the point furthest from the injection point; the lower this quantity, the more homogeneous the foam;
rebound resilience: according to the standard ISO 8307 (a 16.8 g steel ball 16 mm in diameter is dropped from a height of 500 mm onto a foam sample; the rebound resilience then corresponds to the percentage of energy returned to the ball, or percentage of the initial height reached by the ball on rebound);
compression set (comp. set): a measurement is carried out consisting in compressing a sample to a given degree of deformation and for a given time, then in releasing the released stress, and in noting the residual deformation after a recovery time; the measurement is adapted from the standard ISO 7214, with a deformation of 50%, a hold time of 22 h, a temperature of 23° C., and taking a measurement after 30 min.

The properties of the foams are presented in the following table:

| | | | | | Comp. set |
|---|---|---|---|---|---|
| | | | Δ | | after |
| Foam | PEBA | Density | density | Rebound | 30 min |
| no. | no. | (kg/m³) | (kg/m³) | resilience (%) | (%) |
| A | 1 | 325 | 28 | 59 | 26 |
| B | 1 | 250 | 4 | 62 | 35 |
| C | 1 | 210 | 20 | 62 | 38 |
| D | 2 | 183 | 11 | 58 | 30 |
| E | 3 | 291 | 5 | 60 | 20 |
| F | 3 | 240 | 8 | 60 | 23 |
| G | 4 | Not | / | / | / |
| | | foamable | | | |

The various densities for a same PEBA are obtained by modifying the parameters of the foam manufacturing process. The densities of foams C and D correspond to the minimum densities achieved with PEBAs nos. 1 and 2 respectively.

It is observed that the foam of PEBA no. 2 (foam D) has a lower minimum density than the foam formed from PEBA no. 1 (foam C). Furthermore, foam D is more homogeneous, and has a lower compression set after 30 min than foam C, while having similar rebound resilience.

Moreover, by comparing foam B (of PEBA no. 1) and foam F (of PEBA no. 3), it is observed that at a similar density, the foam F has a lower compression set after 30 min than that of foam B.

It was not possible to obtain foam from PEBA no. 4.

1. A branched copolymer containing rigid blocks and flexible blocks, wherein the branchings are made by a polyol residue binding rigid blocks of the copolymer,
said polyol being a polyol comprising at least three hydroxyl groups,
said copolymer having a weight-average molar mass Mw of greater than or equal to 80 000 g/mol, and wherein the ratio of the weight-average molar mass Mw of the copolymer to the number-average molar mass Mn of the copolymer is greater than or equal to 2.2.

2. The copolymer as claimed in claim 1, having a weight-average molar mass Mw ranging from 80 000 to 300 000 g/mol.

3. The copolymer as claimed in claim 1, wherein the ratio of the weight-average molar mass Mw of the copolymer to the number-average molar mass Mn of the copolymer is greater than or equal to 2.4.

4. The copolymer as claimed in claim 1, wherein the ratio of the z-average molar mass Mz of the copolymer to the weight-average molar mass Mw of the copolymer is greater than or equal to 1.8.

5. The copolymer as claimed in claim 1, wherein the rigid blocks are chosen from polyamide blocks, polyester blocks, polyurethane blocks and a combination thereof.

6. The copolymer as claimed in claim 1, wherein the flexible blocks are chosen from polyether blocks, polyester blocks, and a combination thereof.

7. The copolymer as claimed in claim 1, being a copolymer containing polyamide blocks and polyether blocks.

8. The copolymer as claimed in claim 5, wherein the polyamide blocks are blocks of polyamide 6, of polyamide 11, of polyamide 12, of polyamide 5.4, of polyamide 5.9, of polyamide 5.10, of polyamide 5.12, of polyamide 5.13, of polyamide 5.14, of polyamide 5.16, of polyamide 5.18, of polyamide 5.36, of polyamide 6.4, of polyamide 6.9, of polyamide 6.10, of polyamide 6.12, of polyamide 6.13, of polyamide 6.14, of polyamide 6.16, of polyamide 6.18, of polyamide 6.36, of polyamide 10.4, of polyamide 10.9, of polyamide 10.10, of polyamide 10.12, of polyamide 10.13, of polyamide 10.14, of polyamide 10.16, of polyamide 10.18, of polyamide 10.36, of polyamide 10.T, of polyamide 12.4, of polyamide 12.9, of polyamide 12.10, of polyamide 12.12, of polyamide 12.13, of polyamide 12.14, of polyamide 12.16, of polyamide 12.18, of polyamide 12.36, of polyamide 12.T or mixtures thereof, or copolymers thereof.

9. The copolymer as claimed in to claim 6, wherein the polyether blocks are blocks of polyethylene glycol, of propylene glycol, of polytrimethylene glycol, of polytetrahydrofuran, or mixtures thereof, or copolymers thereof.

10. The copolymer as claimed in claim 1, wherein:
the rigid blocks of the copolymer have a number-average molar mass of from 400 to 20 000 g/mol; and/or
the flexible blocks of the copolymer have a number-average molar mass of from 100 to 6000 g/mol.

11. The copolymer as claimed in claim 1, wherein the mass ratio of the rigid blocks relative to the flexible blocks of the copolymer is from 0.1 to 20.

12. The copolymer as claimed in claim 1, wherein the polyol has a weight-average molar mass of less than or equal to 3000 g/mol.

13. The copolymer as claimed in claim 1, wherein the polyol is chosen from: pentaerythritol, trimethylolpropane, trimethylolethane, hexanetriol, diglycerol, methylglucoside, tetraethanol, sorbitol, dipentaerythritol, cyclodextrin, polyether polyols comprising at least three hydroxyl groups, and mixtures thereof.

14. A foam of a copolymer containing rigid blocks and flexible blocks as claimed in claim 1.

15. The foam as claimed in claim 14, having a density of less than or equal to 800 kg/m3.

16. The foam as claimed in claim 14, having a compression set after 30 minutes of less than or equal to 35%.

17. A process of manufacturing a copolymer containing rigid blocks and flexible blocks as claimed in claim 1, comprising the following steps:
the mixing of the polyol with precursors of the rigid blocks;
the synthesis of the rigid blocks;
the addition of the flexible blocks;
the condensation of the rigid blocks and of the flexible blocks.

18. The process as claimed in claim 17, wherein the polyol is mixed in an amount ranging from 0.01% to 10% by weight, relative to the total weight of the polyol, of the precursors of the rigid blocks and of the flexible blocks.

19. A process for manufacturing a foam as claimed in claim 14, comprising the following steps:
the mixing of the copolymer in the melt state, optionally with one or more additives, and with a blowing agent; and
the foaming of the mixture of copolymer and blowing agent.

20. An article consisting of a foam as claimed in claim 14.

21. An article comprising at least one element consisting of a foam as claimed in claim 14.

22. The article as claimed in claim 20, which is chosen from sports shoe soles, large or small balls, gloves, personal protective equipment, rail tie pads, motor vehicle parts, construction parts and electrical and electronic equipment parts.
